(19) United States
(12) Patent Application Publication
(10) Pub. No.: US 2003/0018852 A1
(43) Pub. Date: Jan. 23, 2003

(54) Digital remote store

(75) Inventor: Franklin E. McLinn, Simi Valley, CA (US)

Correspondence Address: MARK C. VAN NESS, BLAKELY, SOKOLOFF, TAYLOR & ZAFMAN, LLP, 12400 WILSHIRE BLVD., SEVENTH FLOOR, LOS ANGELES, CA, 90025, US

(73) Assignee: Xircom, Inc.

(21) Appl. No.: 09/908,502

(22) Filed: Jul. 17, 2001

(51) Int. Cl. G06F 13/00

(52) U.S. Cl. 711/115; 711/103

(57) ABSTRACT

Expanded storage is provided to portable electronic devices of the type that typically incorporate compact flash memory cards or a similar local replaceable memory device. A transceiver assembly is provided within the form factor of the local replaceable memory normally used in the local storage device. The transceiver assembly communicates with the portable electronic device over the connections and using the same communication protocol as the portable electronic device conventionally uses to communicate with the local replaceable memory device. Data are written to the transceiver assembly as if the transceiver were the conventional memory device. The data are buffered and transmitted over a wireless link to a corresponding wireless link associated with a remote mass storage device. Data transferred across the wireless link are stored in the remote mass storage device as if the mass storage were provided within the portable electronic device, thereby providing greatly expanded storage to the portable electronic device.

### BACKGROUND OF THE INVENTION

1. Field of the Invention

The present invention relates to the distributed storage devices and more particularly to a mass storage device that expands the available storage beyond that conventionally provided to hand held or personal electronic devices.

2. Discussion of the Related Art

Hand held or other types of portable electronic devices include digital cameras, digital audio players (e.g., MP3 players), personal digital assistants (PDAs), cellular telephones, hand held Internet terminals and other small computing devices including notebook computers. Portable electronic devices are typically provided with a replaceable or detachable local memory. For example, digital cameras are presently being sold that use as local memories internal floppy disk drives and various types of flash (flash EEPROM) memory. Generally it is desirable for these memory devices to be in whole or at least in part detachable because personal electronic devices, particularly digital cameras, use up memory rapidly. Detachable memory devices allow memory to be replaced or supplemented when it gets full.

Flash memory cards are devices based on small circuit boards carrying a quantity of flash memory, a contact structure that allows the flash memory cards to be removably attached to a system, and generally a controller that implements a communication interface and protocol. For example, many flash memory cards implement in whole or in part the ATA or ATA/IDE standards. Flash memory cards are widely implemented in portable electronic devices because the cards provide relatively high speed, non-volatile and compact storage. On the other hand, flash memory cards are typically expensive because of the comparative expense of flash memory and are of limited storage capacity. While the price per bit of flash memory is falling and is expected to continue falling, the demand for increased storage capacity on portable electronic devices is growing at a significantly faster rate. As such, the relative expense of a flash memory card for a portable electronic device is expected to remain unacceptably expensive.

### SUMMARY OF THE PREFERRED EMBODIMENTS

Aspects of the present invention include an expanded memory 20 system that can replace a local memory used by a portable electronic device. The expanded memory system includes a transceiver assembly adapted to replace a local memory in an electronic device. The local memory device defines a first set of connections to the electronic device and a first communications interface with the electronic device. Preferably the transceiver assembly has a second set of connections compatible with the first set of connection and a second communications interface compatible with the first communications interface. The expanded memory system further includes a mass storage unit having a wireless communications link with the transceiver assembly. The mass storage unit includes mass storage so that data provided to the transceiver assembly by the electronic device is stored in the mass storage of the mass storage unit.

### BRIEF DESCRIPTION OF THE DRAWINGS

These and other aspects of the present invention may be understood with reference to the drawings, which form a part of the present disclosure and are briefly described here.

FIG. 1 illustrates an implementation of a transceiver, associated circuitry and an interface to connect a portable electronic device to a remote mass storage device.

FIG. 2 illustrates an implementation of a transceiver, associated circuitry and a mass storage device preferably used in cooperation with the assembly of FIG. 1 to provide expanded storage for a portable electronic device.

### DETAILED DESCRIPTION OF THE PREFERRED EMBODIMENTS

Preferred embodiments of the present invention provide expanded memory to portable electronic devices of the type that typically incorporate a compact flash memory card or a similar replaceable memory device. Exemplary portable electronic devices include digital cameras, personal digital assistants (PDAs), digital audio players and small computing devices. In normal use, these portable electronic devices can have strong memory demands and can fill several flash memory cards, whether for data or application programs. Having to use multiple replacement memory devices to store desired amounts of information is both inconvenient and expensive. The expanded memory provided in accordance with preferred aspects of the present invention can be low cost as compared to the equivalent cost of an equivalent capacity of flash memory cards. Most preferably, the expanded memory interfaces to the portable electronic device in the same manner as does the replaceable memory device, so the expanded memory has the same functional appearance to the portable electronic device as does the conventional local replaceable memory.

Preferred implementations of the present invention provide a transceiver assembly adapted to be mounted in the portable electronic device, a mass storage device that can be positioned remotely from the portable electronic device and a wireless link between the transceiver assembly and the mass storage device. The mass storage device may be a large integrated circuit memory but is more preferably a hard disk drive because of the large capacity and the low cost of such disk drives. The wireless link may be an infrared data link in some embodiments that accommodate line of sight couplings. In other, presently preferred implementations, the wireless link is a radio frequency (RF) coupling that does not require line of sight access. For example, particularly preferred embodiments utilize RF links using the Bluetooth protocol and the presently commercially available Bluetooth transceivers. Other implementations may use other RF links such as 802.11a or HiperLAN, depending on the availability and cost of such devices.

A transceiver assembly preferably is provided within the form factor of the local replaceable memory normally used in the local storage device. What this means is that the preferred transceiver assembly has the shape, size and connections used in the conventional flash memory card or other replaceable local memory device. Certain flash memory cards utilize proprietary interfaces but the majority of such replaceable memory devices have sizes and interfaces dictated by one or more accepted industry standards. Such standards include the Compact Flashcard, the Smart Media Flash Card, and the ATA Flash PC Card. Other standard form factors and protocols have been introduced such as Sony's Memory Stick. Additional standards are expected to be introduced and to be adopted from time to time. The particular configuration of the local memory device replaced by implementations of the present invention is not central to the present invention. Those of ordinary skill can provide a transceiver within the presently available form factors and utilizing the presently practiced communication interfaces and protocols. For example, the implementation of an ATA or ATA/IDE interface and protocol is routine to those of ordinary skill in this art. As such, the details of particular implementations, which are expected to vary with different implementations of the invention, are not described in detail here.

The transceiver assembly communicates with the portable electronic device over the connections and using the same communication protocol as the portable electronic device conventionally uses to communicate with its local replaceable memory device. Data are written to the transceiver assembly as if the transceiver were the conventional memory device. The data are buffered and transmitted over a wireless link to an associated remote mass storage device. Data transferred across the wireless link are stored in the remote mass storage device as if the mass storage were provided within the portable electronic device, thereby providing greatly expanded storage to the portable electronic device.

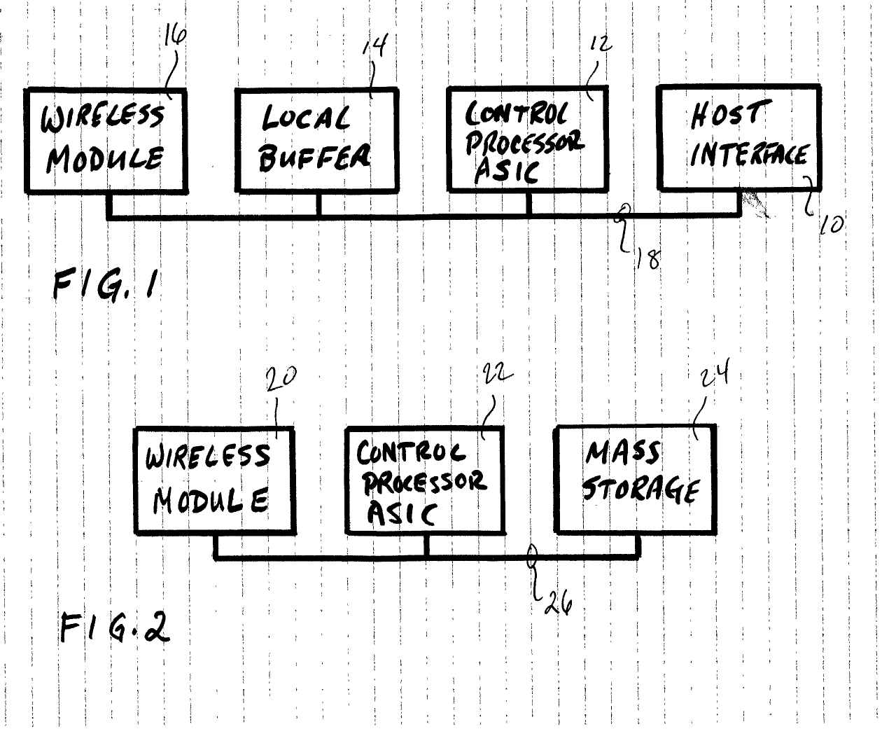

FIG. 1 illustrates an implementation of the transceiver assembly to be installed in place of the flash memory card or other replaceable local memory device in the portable electronic device. In most present implementations, all of the components illustrated in FIG. 1 are provided within the form factor of the flash memory card or other local memory device to be replaced by the FIG. 1 assembly. There may be instances when a portion of the transceiver assembly extends beyond the form factor of the replaceable local memory device, for example by extending an antenna from the form factor external to the portable electronic device. Such instances are presently not preferred, as it is believed that a match between the form factor of the replaceable memory device and the transceiver assembly is desirable. Moreover, satisfactory performance is obtained using such a compact transceiver assembly, so long as the mass storage device is reasonably close to the transceiver assembly.

Within the transceiver assembly of FIG. 1 are a host interface 10, a control processor ASIC 12, a buffer memory 14 and a wireless module 16, with all of these circuits connected by a bus 18 or a functionally equivalent serial connection. Host interface 10 is largely similar to the interface of the replaceable local memory device. For example, host interface 10 may include the connections used in a Smart Media Card, if that is the type of memory used in the target portable electronic device. The host interface 10 preferably includes registers or similar structures used by the communications interface and protocol used by the memory device being replaced by the transceiver assembly. For example, if the personal electronic device uses a flash memory card that uses the ATA communications interface and protocol, the host interface 10 preferably includes a set of ATA registers and other registers and communications signals sufficient to implement the memory device's interface.

In practice, the host interface 10 may include a small memory, such as a FIFO that temporarily stores the data transferred from the personal electronic device to the transceiver assembly. Alternately, depending on the data transmission rates within the transceiver, it may be possible to write data directly from the host interface over the bus 18 to a local buffer memory 14. Since the transceiver assembly of FIG. 1 and the host interface 10 are preferably bidirectional, the buffer memory may store data that is being sent from the portable electronic device to the mass storage device and from the mass storage device to the portable electronic device.

There will also be a bidirectional flow of command and status information, at least between the control processor ASIC 12 and the host portable electronic device and between the control processor ASIC 12 and the mass storage device. The control and status information exchanged between the processor 12 and the host portable electronic device is expected to be like that normally exchanged between the host portable electronic device and the memory conventionally installed in the portable electronic device. Such communications are preferably carried out in accordance with the host interface of the replaced memory device and generally have similar content. Additional status information and commands certainly might be implemented, providing additional functionality to the expanded memory, but the presently contemplated implementation of this aspect of the present invention does not require such additional functionality.

This simple implementation allows the expanded memory to appear to the user of the portable electronic device as a larger version of the conventional local memory provided to the portable electronic device. While such additional functionality may be desirable in certain instances, the additional functionality will be more dependent on the nature of the portable electronic device. The simple implementation of the expanded memory is expected to be usable in most of the applications in which the replaceable local memory device is used. Thus, an implementation of an expanded memory system in accordance with the present invention adapted to replace a Smart Media Card desirably can be used in most applications in which a Smart Media Card can be used. Further to this, it is desirable that the transceiver assembly operates using voltage and power levels conventionally provided to the replaceable memory device.

The control and status information exchanged between the processor and the mass storage device is like that exchanged between a processor and a hard disk drive or another form of mass storage. The control processor 12 within the transceiver assembly controls the operation of each of the components of the transceiver assembly.

The wireless module 16 shown in FIG. 1 may provide a wireless transceiver in accordance with any number of widely implemented wireless communication schemes. For example, in situations where line of sight connectivity can be maintained between the portable electronic device and the mass storage unit, the wireless transceiver is desirably an infrared data connection. In other, more common instances where line of sight connectivity is not convenient, the wireless module 16 is a Bluetooth or other RF transceiver. Data buffered in the local buffer memory 14 are transferred to the wireless module 16, formatted appropriately, encoded and transmitted to the corresponding transceiver 20 in the mass storage unit shown in FIG. 2. Similarly, data received by the transceiver 16 in the transceiver assembly of FIG. 1 are detected, decoded, formatted and preferably stored in the buffer memory. The particular operations and buffering schemes used for transmitting and receiving data will vary somewhat with different communication schemes and different implementations.

The mass storage unit shown in FIG. 2 corresponds to the wireless transceiver assembly shown in FIG. 1. Data sent by the transceiver assembly of FIG. 1 are received by a wireless transceiver 20 corresponding to the wireless communication scheme used in the transceiver assembly of FIG. 1. Thus, if wireless transceiver 16 uses infrared, wireless module 20 also uses infrared. In presently preferred implementations, both the wireless modules use Bluetooth protocols and RF transmission to send and receive data between the two parts of the overall expanded memory system.

The mass storage unit of FIG. 2 includes the appropriate wireless module 20, a control processor ASIC 22 that controls operation of the mass storage unit and the mass storage 24 itself. Communications between the wireless module 20 and the mass storage unit are conducted over the bus 26 or similar interconnection and are controlled by the control processor 22. The control processor 22 includes the functionality of a memory controller as well as controlling the communications between the two wireless modules 18, 20 that define the wireless line within the expanded memory system. As discussed above, the mass storage 24 may be any type of memory including a large integrated circuit memory (preferably SRAM or DRAM) or, more preferably, a hard disk drive. Preferably, the mass storage 24 is provided with its own power supply such as a battery. Generally, this battery is also used to power the control processor ASIC 22 and the wireless module 20.

The present invention has been described here with respect to certain preferred embodiments thereof. Those of ordinary skill will appreciate that various modifications and alternate embodiments of the invention might be practiced without varying from the basic teachings of the present invention. As such, the present invention is not to be limited to any particular described embodiment hereof. Rather, the scope of the present invention is to be determined from the claims, which follow.

What is claimed:

1. An expanded memory system for replacing a replaceable local memory used by a portable electronic device, the memory system comprising:
a transceiver assembly adapted to replace a local memory in an electronic device, the local memory device defining a first set of connections to the electronic device and a first communications interface with the electronic device, the transceiver assembly having a second set of connections compatible with the first set of connection and a second communications interface compatible with the first communications interface; and
a mass storage unit having a wireless communications link with the transceiver assembly, the mass storage unit including mass storage so that data provided to the transceiver assembly by the electronic device is stored in the mass storage of the mass storage unit.

2. The expanded memory system of claim 1, wherein the transceiver assembly includes a first wireless module and the mass storage unit includes a second wireless module and wherein the wireless communications link is between the first and second wireless module.

3. The expanded memory system of claim 2, wherein the first and second wireless modules are infrared data links.

4. The expanded memory system of claim 2, wherein the first and second wireless modules are RF data links.

5. The expanded memory system of claim 4, wherein the first and second wireless modules communicate according to the Bluetooth protocol.

6. The expanded memory system of claim 1, wherein the transceiver assembly is sized and shaped substantially similar to the local memory device.

7. The expanded memory system of claim 6, wherein the local memory device is a Smart Media Card.
